(19) United States
(12) Patent Application Publication
(10) Pub. No.: US 2009/0252033 A1
(43) Pub. Date: Oct. 8, 2009

(54) SYSTEM AND METHOD OF DISTRIBUTING MEDIA CONTENT

(75) Inventors: Kadangode Ramakrishnan, Berkeley Hgts., NJ (US); Robert Duncan Doverspike, Tinton Falls, NJ (US); Guangzhi Li, Madison, NJ (US); Dongmei Wang, Madison, NJ (US); Kostas Oikonomou, Colts Neck, NJ (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Knowledge Ventures, L.P., Reno, NV (US)

(21) Appl. No.: 12/099,535

(22) Filed: Apr. 8, 2008

(51) Int. Cl. H04L 12/26; H04L 12/28

(52) U.S. Cl. 370/228; 370/254

(57) ABSTRACT

Systems and methods to distribute media content are provided. A particular method includes receiving first link weighting factors and second link weighting factors at a router of a node of a multicast network and determining a primary path to a next hop node based on the first link weighting factors. Additionally, the method includes determining a backup path from a router of the primary path to the next hop node based on the second link weighting factors. The backup path does not overlap any primary path between two nodes of the network. Further, the method includes receiving a data packet from a parent node and routing a copy of the data packet from the router to the next hop node via the backup path, when a network link related to the router has failed. The method also includes routing data packets via a re-configured multicast tree that excludes the failed link.

### FIELD OF THE DISCLOSURE

The present disclosure relates generally to distributing media content.

### BACKGROUND

Television and other video service providers can provide media services to multiple households. As service areas become larger, network infrastructure is typically expanded. Nonetheless, distributing multimedia content, especially television content or other video content, via a network typically requires high bandwidth combined with tight latency and loss constraints, even under failure conditions. If a component in such a network fails, continuing to distribute media content via the network often requires identification and repair of the failure; re-routing of data packets around the point of failure; re-generating data packets at a head-end device; or other solutions. Some solutions can cause network congestion, packet loss or other delays in data traffic. Multiple network failures can compound these effects, which can significantly impact the quality of media content.

### BRIEF DESCRIPTION OF THE DRAWINGS

FIG. 1A is a block diagram of a particular illustrative embodiment of a system to distribute media content;

FIG. 1B is a block diagram of a particular illustrative embodiment of an initial multicast tree related to the system illustrated in FIG. 1A;

FIG. 1C is a block diagram of a particular illustrative embodiment of a re-configured multicast tree related to the system illustrated in FIG. 1A;

FIG. 2A is a block diagram of a second particular illustrative embodiment of a system to distribute media content, in which a back-up path overlaps primary paths of a multicast tree;

FIG. 2B is a block diagram of the system to distribute media content illustrated in FIG. 2A, in which the back-up path does not overlap primary paths of the multicast tree;

FIG. 2C is a block diagram of the system to distribute media content illustrated in FIG. 2A, in which multiple failures have occurred;

FIG. 3A is a block diagram of a third particular illustrative embodiment of a system to distribute media content, in which at least one network failure is illustrated;

FIG. 3B is a block diagram of a multicast tree associated with the system illustrated in FIG. 3A;

FIG. 4 is a block diagram of a fourth particular illustrative embodiment of a system to distribute media content;

FIG. 5 is a flow diagram of a particular illustrative embodiment of a method of distributing media content;

FIG. 6 is a flow diagram of a second particular illustrative embodiment of a method of distributing media content;

FIG. 7 is a flow diagram of a third particular illustrative embodiment of a method of distributing media content;

FIG. 8 is a flow diagram of a fourth particular illustrative embodiment of a method of distributing media content; and

FIG. 9 is a diagram of an illustrative embodiment of a general computer system.

### DETAILED DESCRIPTION OF THE DRAWINGS

A system to distribute media content is disclosed. The system includes a router associated with a node of a media distribution network. The router is adapted to receive a data packet from a parent node of the media distribution network. The router is also adapted to route a copy of the data packet to a next hop node via a fast re-route backup path when a network link coupled to the router and to a second router of a next hop node is not operational. The fast re-route backup path does not overlap any primary path of an initial multicast tree corresponding to data flow from the router to downstream nodes of the media distribution network. Additionally, the router is adapted to construct a re-configured multicast tree that excludes the failed network link and route data packets via the re-configured multicast tree and cease routing data packets via the backup path in response to a re-convergence event.

In another embodiment, a system to distribute media content includes a router associated with a node of a media distribution network. The router is adapted to determine a primary path to a next hop media distribution node based on first link weighting factors received at the router. The primary path corresponds to a network link coupled to the router and to a second router of a next hop media distribution node. The router is also adapted to determine a backup path from the router to the next hop media distribution node based on second link weighting factors received at the router, where the backup path does not overlap an initial multicast tree that includes the primary path. Additionally, the router is adapted to route a copy of a data packet received at the router from a parent node to the next hop media distribution node via the backup path when a network link coupled to the router and to the second router is not operational. Further, the router is adapted to determine a re-configured multicast tree that excludes the network link that is not operational and route data packets via the re-configured multicast tree and cease routing data packets via the backup path in response to a re-convergence of a routing protocol.

In another embodiment, a method of distributing media content includes

setting a plurality of link weighting factors for a plurality of links of a multicast network, according to a process that includes identifying a first plurality of nodes of the multicast network, where the first plurality of nodes include a media content source and are connected via a first plurality of links to form a first ring. The process also includes setting a weighting factor associated with a particular link of the first plurality of links to a high cost and setting weighting factors associated with the other links in the first plurality of links to a low cost, where the particular link is coupled to the media content source. Additionally, the process includes forming a graph representing the multicast network. The graph includes links of the multicast network that are associated with weighting factors and each pair of nodes connected via one of the included links. Further, the process includes identifying at least one additional series of links of the multicast network, where each additional series of links are unweighted and form a path having two endpoints on the graph of the multicast network and setting a weighting factor associated with a first or a last link in the additional series of links to the high cost and setting weighting factors associated with other links in the additional series of links to the low cost. The method also includes downloading data related to the plurality of link weighting factors to each of a plurality of media destination routers of the multicast network, where the plurality of media destination routers are adapted to send and receive data packets according to a multicast tree that includes each of the plurality of links whose weighting factor is equal to the low cost.

In another embodiment, a method of distributing media content includes receiving first link weighting factors and second link weighting factors at a router associated with a media distribution node of a multicast media distribution network and determining a primary path to a next hop media distribution node based on the first link weighting factors. The primary path corresponds to a network link coupled to the router and to a second router of the next hop media distribution node and wherein the network link is associated with a low first link weighting factor. The method also includes determining a backup path from the router to the next hop media distribution node based on the second link weighting factors, where the backup path does not overlap any primary path between two media distribution nodes of the media distribution network. Additionally, the method includes receiving a data packet from a parent media distribution node and routing a copy of the data packet from the router to the next hop node via the backup path, when the network link coupled to the router and to the second router has failed.

A computer-readable medium having processor-readable instructions that are executable by a processor to perform a method that includes setting a plurality of link weighting factors for a plurality of links of a multicast network, according to a process that includes identifying a first plurality of nodes of the multicast network, where the first plurality of nodes include a media content source and are connected via a first plurality of links to form a first ring. The process also includes setting a weighting factor associated with a particular link of the first plurality of links to a high cost and setting weighting factors associated with the other links in the first plurality of links to a low cost, where the particular link is coupled to the media content source. Additionally, the process includes forming a graph representing the multicast network. The graph includes links of the multicast network that are associated with weighting factors and each pair of nodes connected via one of the included links and identifying at least one additional series of links of the multicast network, where each additional series of links are unweighted and form a path having two endpoints on the graph of the multicast network. Further, the process includes setting a weighting factor associated with a first or a last link in the additional series of links to the high cost and setting weighting factors associated with other links in the additional series of links to the low cost. The computer readable medium also has processor-readable instructions that are executable by the processor to perform a method including downloading data related to the plurality of link weighting factors to each of a plurality of media destinations of the multicast network.

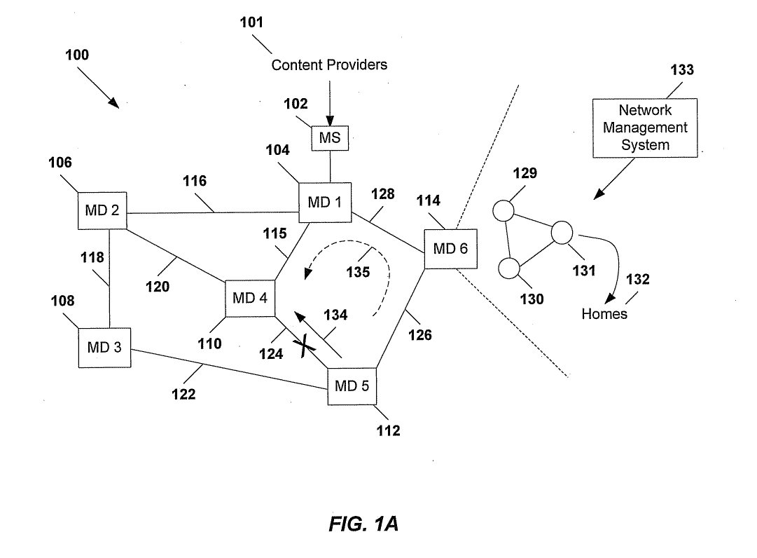

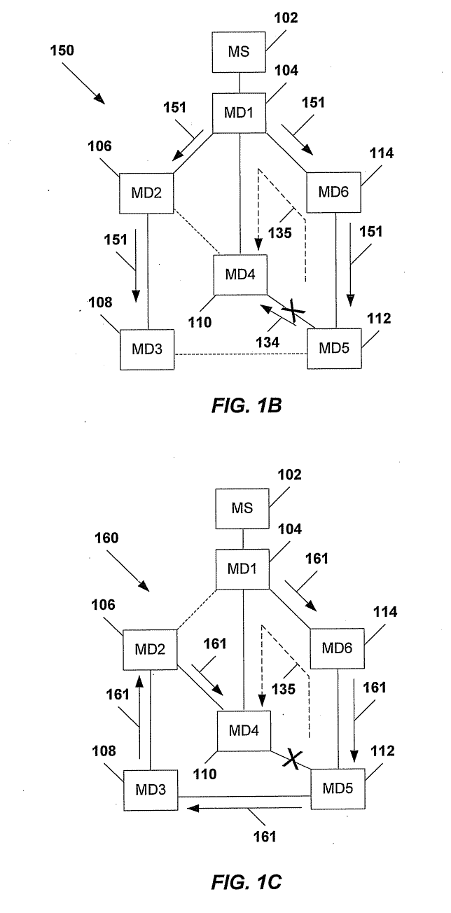

Referring to FIG. 1, a particular illustrative embodiment of a system to distribute media content is illustrated and designated generally 100. The system 100 includes a media content source 102 and a plurality of media destinations 104-114. The media content source 102 and the plurality of media destinations 104-114 communicate with each other via a plurality of network links 115-128. In a particular embodiment, the media destinations 104-114 and the network links 115-128 can form a multimedia IP backbone network to distribute Internet Protocol Television (IPTV) content from an IPTV service provider to various subscribers. In an illustrative embodiment, the links can comprise bi-directional Internet Protocol (IP) links that each include an upstream portion and a downstream portion. The network links can be adapted to transmit data according to various protocols such as Packet-over-SONET (POS), IP-over-Ethernet, IP-over-ODU (ITU signals), or other transport protocols and technologies that each includes an upstream portion and a downstream portion. In a multicast tree, where the router nodes are interconnected in a tree-like topology, each media destination receives only one copy of each data packet sent from a media content source, and a data packet traverses a link only once. The downstream portion of the link is between a first media destination and a child media destination towards which the first media destination forwards traffic. The upstream portion of a link is between a first media destination and a parent media destination from which the first media destination receives media packets.

In a particular embodiment, the media content source 102 can be a video head-end, such as a super, national or regional video head-end. The media content source 102 can include one or more satellite receivers, data servers, or other systems that receive media content, such as video content, audio content, or any combination thereof, from one or more content providers 101. Moreover, the media content source 102 can include a plurality of routers. In an illustrative embodiment, the media content source 102 can include one router per IPTV channel served to the media destinations 104-114. The media content source 102 can send the media content to the media destinations 104-114 via Internet Protocol (IP) communication using a Moving Pictures Experts Group (MPEG) stream or other packet-based mechanism suitable to send media content. In an illustrative, non-limiting embodiment, the media content source 102 can include devices and systems, such as a low-noise block-down converter and other systems, to convert a satellite signal to packet data.

Each of the media destinations 104-114 functions as a media distribution node that receives media data packets, or copies thereof. The media data packets may include video content, audio content, or any combination thereof. The media destinations 104-114 may multicast the received media data packets to various serving areas that may include regional or sub-regional media distribution nodes, set-top box devices at the subscriber homes 132, or any combination thereof. In a particular embodiment, each of the media destinations 104-114 can include one or more servers, multicast-enabled routers, or other devices, each of which can include interfaces, logic, memory devices, other components, or any combination thereof, adapted to perform one or more of the functions of the media destination with respect to distributing media content, such as receiving a data packet, sending a data packet, storing data, determining one or more network paths, and other functions. In an illustrative embodiment, each media destination can include a designated router 129 and a backup designated router 130 that are coupled to each other and to one or more multimedia servers 131. In an illustrative, non-limiting embodiment, the designated router 129 and the backup designated router 130 can operate as redundant, or substantially redundant, network edge devices.

Routers at the media content source 102 and the media destinations 104-114 can send data packets, such as video packets, associated with media content, to each other via the network links 115-128. The flow of data through the network can be represented as a multicast tree, such as a source-specific multicast tree having a router at the media content source 102 as its root. The multicast tree indicates an order in which the media destinations 104-114 receive copies of each data packet sent by a router at the media content source 102 and is not necessarily the same as the sequence in which the media destinations 104-114 are physically connected to the media content source 102. For example, as shown in FIG. 1B, data packets can be sent from MD(1) 104 to MD(6) 114 via an initial multicast tree. In another example, data packets can be sent from MD(5) 112 to MD(4) 110 via the same initial multicast tree.

The initial multicast tree is determined based on a plurality of primary paths associated with the system 100. Each primary path is associated with one of the network links 115-128 and indicates a direction of downstream (as defined earlier) data travel between two network nodes. In a particular embodiment, the primary paths on which the multicast tree is based can be determined by the media destinations 104-114. Each of the media destinations 104-114 can select an initial primary path to a downstream network destination (i.e. a “next hop node”), based on link bandwidth costs (e.g., an available bandwidth or inverse of available bandwidth) or other link weighting factors associated with the network links to which the media destination is coupled.

For example, if a link weighting factor associated with a link between MD(2) 106 and MD(3) 108 is equal to 1, and a link weighting factor associated with a link between MD(2) 106 and MD(4) 110 is equal to ∞, then MD(2) 106 can select MD(3) 108 as the next hop node. Consequently, the initial multicast tree associated with the system 100 can include an initial primary path directed from MD(2) 106 to MD(3) 108 via the network link 118. Examples of primary paths associated with an initial multicast tree are illustrated in FIG. 1B at 134 and 151. Those skilled in the art will appreciate that network nodes can be adapted to select low cost links in determining a next best hop, or to select high cost links in determining a next best hop, depending on what each link cost represents.

In a particular embodiment, a Protocol-Independent Multicast (PIM) protocol, such as PIM Sparse Mode (PIM-SM) or PIM Source Specific Multicast (PIM-SSM), can be used to determine the initial multicast tree based on the plurality of initial primary paths associated with the system 100, such that this tree includes the low cost links of the system 100. The topological state of the system 100 can be maintained via an interior gateway protocol (IGP), such as an open shortest path first (OSPF) protocol, OSPF version 3 (OSPFv3) protocol, intermediate system-to-intermediate system (IS-IS) protocol, multicast OSPF (MOSPF) protocol, or other link-state routing protocol, where the routers associated with the media content source 102 and the routers at the plurality of media destinations 104-114 each store information about the complete network topology and calculate the best next hop to each of the other possible destinations (i.e., connected media destinations) based on link costs or other link weighting factors.

In an illustrative embodiment, each of the routers at the media destinations 104-114 can store a link state database that indicates the entire network topology, as well as a routing table that includes data indicating (a) which nodes of the network are connected to particular other nodes; (b) the shortest paths to other nodes (such as the root of the multicast tree or a desired parent node); (c) the primary path to a next hop node; or (d) any combination thereof. Additionally, each of the routers can store state information related to a portion of the initial multicast tree that is relevant to the particular router. Such a portion of the initial multicast tree can include, for example, the router, child nodes downstream from the router, and one or more shortest paths from the router to the router at the root of the initial multicast tree (i.e., a router at the media content source 102). The router at the media destination can determine the portion of the initial multicast tree based on multicast JOIN messages sent by downstream media destinations to the media content source 102 via the router.

For instance, the router can receive a JOIN message related to a particular IPTV channel from a second router at a next hop node of the media distribution network, where the next hop node has received a request for the channel from a set-top box device. If the router is already receiving media packets related to the requested channel, the router can append the primary path from the router to the next hop node to a multicast tree for the channel, which extends from a router at the media content source 102 to the router. Whereas, if the router is not receiving media packets related to the requested channel, the router can store link state information indicating that it is to send copies of the media packets related to the next hop node, and it can forward the JOIN message toward the media content source 102 via a shortest open path determined from its routing table. Once the router is appended to the multicast tree for the channel, the router can append the primary path to the next hop node to the multicast tree for the channel, as well.

After an initial multicast tree is determined for the system 100, a second set of link weighting factors can be determined for the network links 115-128 and can be distributed to the routers at the media destinations 104-114. Using the second set of weighting factors, each of the media destinations 104-114 can determine and store an initial backup path to send media data packets to a next media destination during a link failure. For example, if a link associated with an initial primary path between a first media destination and a next media destination fails due to physical damage of the link, router line card failures, router mis-configuration, network upgrades or maintenance, or other failure conditions, the first media destination can send media data packets to the next media destination via the initial backup path. In a particular embodiment, the initial backup path can include a “virtual link” between the first media destination and the next media destination whose direction is opposite to that of the initial primary path from the first media destination to the second media destination, as explained below. To illustrate, in the embodiment shown in FIG. 1A, MD(5) 112 can send data packets to MD(4) 110 via an initial primary path 134 associated with the link 124. If the link 124 fails, MD(5) 112 can send data packets to MD(4) 110 via a virtual link between MD(5) 112 and MD(4) 110, namely the backup path 135. Both the initial primary path 134 and the backup path 135 begin at MD (5) 112 and end at MD (4) 110. The backup path 135, however, traverses links in a direction opposite to that of the initial primary path 134. In an illustrative embodiment, the backup path 135 may include the upstream portion of a link between the first media destination and a parent media destination from which the first media destination receives media data packets. For instance, the backup path 135 includes an upstream portion of the link 126 between MD(5) 112 and MD(6) 114. The backup path 135 can also include upstream portions of links between other media destinations, such as the link 128 between MD(6) 114 and MD(1) 104. The use of upstream portions of certain links to re-route data can exploit the asymmetric nature of typical multicast media content (i.e., downstream traffic from the media source is much bigger than upstream traffic to the media source).

In a particular embodiment, a service provider, or other party or automated system, can determine that an initial multicast tree corresponding to the system 100 is to meet one or more criteria. For instance, it can be determined that each media destination should only receive one copy of each data packet sent from the media content source 102. In another example, it may be determined that no backup path should overlap any primary path related to the initial multicast tree. Link weighting factors can be set for the links 115-128 to manipulate selections of one or more of the initial primary paths by each of the media destinations 104-114, such that the resulting initial multicast tree meets the desired criteria.

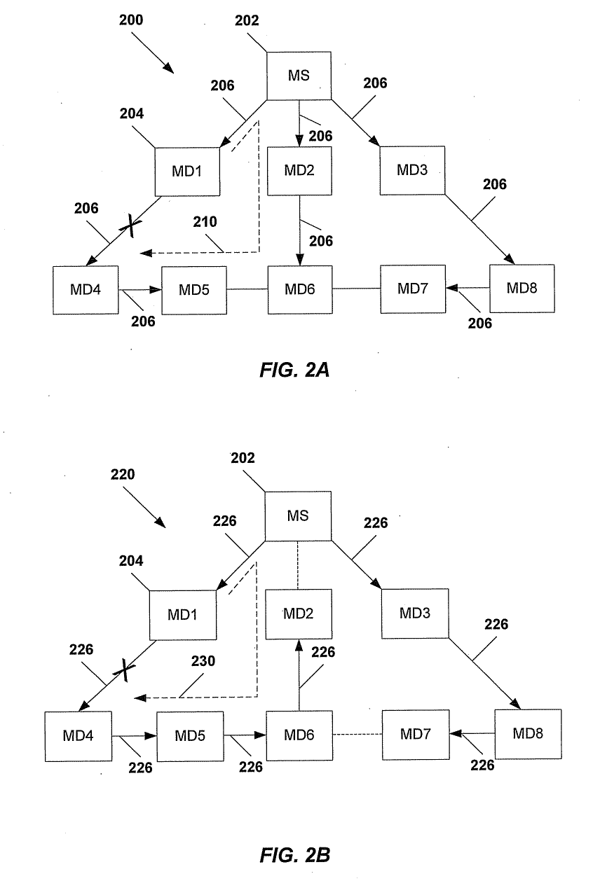

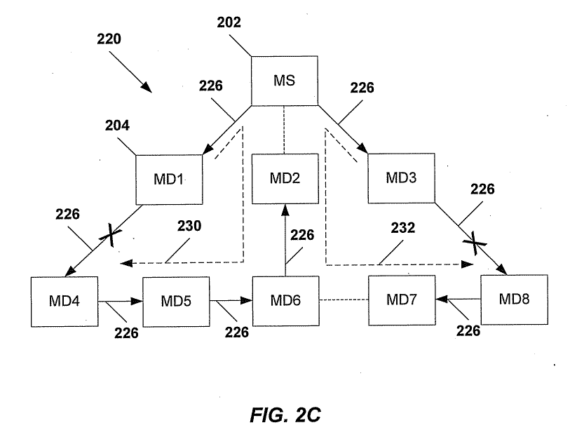

Link weighting factors can be set to produce an initial multicast tree in which each of the media destinations 104-114 receives only one copy of each media data packet sent by the media content source 102. In addition, link weighting factors can be set to produce an initial multicast tree in which each media destination receives data packets via a shortest open path from the media content source 102. Further, the link weighting factors can be set to produce an initial multicast tree in which no backup path overlaps any initial primary path of the initial multicast tree. In this way, downstream network congestion will typically not increase, at least under single link failures, as a result of sending media data packets via a backup path, such as the backup path 135. For illustrative purposes, examples of a system in which network congestion is, and is not, increased as a result of using a backup path are illustrated in FIGS. 2A and 2B, respectively, as described below.

In one embodiment, link weighting factors can be set by a network management system 133 and can be communicated to the routers associated with media content source 102, and to the routers at each of the media content destinations 104-114, as IGP link weighting factors. Alternatively, such link weighting factors can be manually entered at the routers associated with the media content source 102, at routers associated with one or more of the media destinations 104-114, at the network management system 133, or any combination thereof. In another example, the link weighting factors can be included with router configuration software loaded onto routers at the media content source 102 and the media destinations 104-114. Link weighting factors can be set according to the methods described with reference to FIGS. 1B-8.

FIG. 1B depicts an illustrative example of an initial multicast tree 150 corresponding to the system 100 depicted in FIG. 1A. Link weighting factors can be set, such that the media destinations select the initial primary paths labeled 151 and 134. For instance, link weighting factors associated with links between MD(1) and MD(2), and between MD(1) and MD(6), can be pre-defined as 1; whereas, a link weighting factor associated with the link between MD(1) and MD(4) can be pre-defined as ∞. Thus, MD(1) sends data directly to MD(2) and MD(6), but not directly to MD(4). As a result, the backup path 135 from MD(5) to MD(4) does not overlap any primary path of the multicast tree 150. Rather, the backup path 135 flows in reverse to each primary path of the multicast tree 150 with which the backup path shares a network link.

Upon failure of a network link, such as the network link between MD(5) and MD(4), data packets sent via the initial primary path 134 can be re-routed via the backup path 135. Using the backup path 135 can reduce or eliminate the short-term impact of a link failure on quality of service provided to end users. In an illustrative embodiment, the backup path 135 can be activated by a link-layer fast re-route (FRR) mechanism upon detection of a link failure, such that re-routing of data can tale, in some cases, 50 milliseconds or less. Nonetheless, the utility of the backup path 135 may be frustrated if additional link failures occur in the system 100. As a result, an initial multicast tree can be re-configured to avoid or mitigate the impact of additional link failures. Though multicast tree re-configuration can take up to 10 seconds or more, it allows the system 100 to avoid relatively long-term dependence on the backup path 135 (i.e., at least several hours until the failed link is actually repaired). Hence, the backup path 135 can be used to re-route traffic around a failed link during re-configuration of the multicast tree, and the re-configured multicast tree can then be used to route data traffic without reliance on the failed link or the backup path 135.

In order to re-configure a multicast tree, link weighting factors for some or all of the network links can be re-computed to manipulate the selection of new primary paths by the routers at one or more of the media destinations 104-114, where the new primary paths provide the shortest path from the media content source 102 to each of the media destinations 104-114, while avoiding the failed link and meeting (to the extent possible) the desired criteria of the initial multicast tree, such as each media destination only receiving one copy of each data packet and backup paths not overlapping primary paths of the re-configured multicast tree. Each media destination router re-calculates its best next hop based on the re-computed link weighting factors. As a result, a new plurality of primary paths can be determined by the media destinations, and a re-configured multicast tree can be produced based on the new plurality of primary paths. Zero or more of the new plurality of primary paths can be identical to the initial primary paths.

An example of a re-configured multicast tree 160 is illustrated in FIG. 1C. The re-configured multicast tree 160 is based on a plurality of new primary paths 161. The plurality of new primary paths 161 avoid the failed link between MD(5) 112 and MD(4) 110. In a particular embodiment, MD(5) 112 can send data packets to MD(4) 110 via the backup path 135 until a failed link is repaired. Alternatively, MD(5) 112 can send data packets to MD(4) 110 via the backup path 135 until the re-configured multicast tree is produced and until each media destination joins the re-configured multicast tree, and leaves the initial multicast tree, as further described herein.

Referring to FIG. 2A, a multicast tree representing data flow in a second particular embodiment of a system to distribute media content is illustrated and designated generally 200. The system includes a media distribution network having a plurality of nodes, including a media content source 202 and a plurality of media destinations 204. The plurality of nodes are connected via a plurality of network links. The multicast tree 200 includes a plurality of primary paths 206. In a particular embodiment, a backup path 210 that is used to re-route data packets in response to a link failure between MD(1) to MD(4) overlaps the primary path associated with the network link between the media content source 202 and MD(2), as well as the primary path associated with the network link between MD(2) and MD(6). Thus, re-routing data packets via the backup path 210 can add network congestion by increasing the downstream load on the link between the media content source 202 and MD(2), and on the link between MD(2) and MD(6).

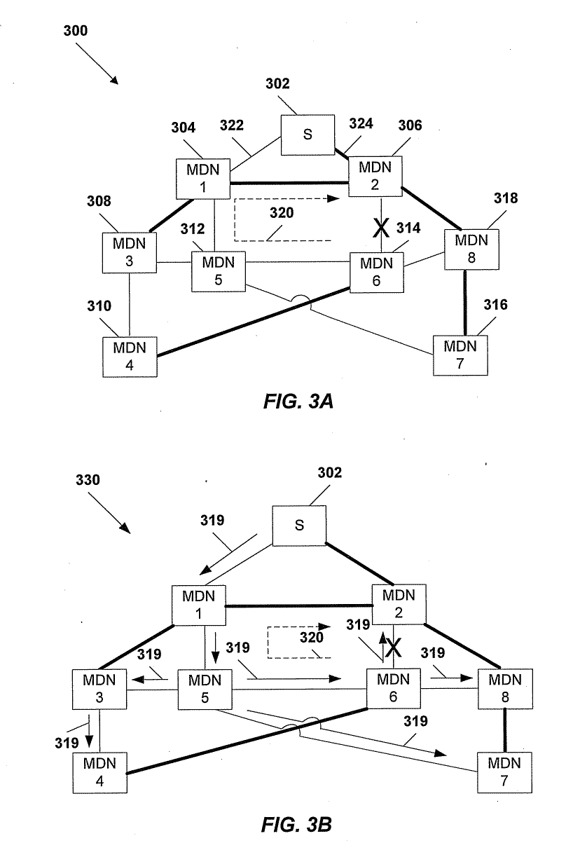

Referring to FIG. 2B, a second multicast tree representing data flow in the system shown in FIG. 2A is illustrated and designated generally 220. In contrast to FIG. 2A, the multicast tree 220 includes a plurality of primary paths 226 that are determined such that the backup path 230 does not overlap the primary paths 226 of the multicast tree 220. Additionally, other backup paths associated with the system, such as the second backup path 232 illustrated in FIG. 2C, do not overlap the primary paths 226 of the multicast tree. Thus, re-routing data packets via the backup path 230 will typically not add network congestion, at least under a single link failure. For example, the downstream load on the link between MD(2) and MD(6) will not be increased, because re-routed data packets will be traveling in the reverse direction, using the upstream portion of the link. The multicast tree illustrated in FIG. 2B can be achieved by setting link weighting factors that cause the media destinations to calculate primary paths 206 in accordance with the multicast tree 220. Methods to set link weighting factors in order to produce a desired multicast tree are described with reference to FIGS. 3A-B.

Referring to FIG. 3A, a third particular embodiment of a system to distribute media content is illustrated and designated generally 300. The system 300 includes a source node 302, such as a video head-end, and a plurality of media distribution nodes 304-318 that are adapted to receive copies of data packets from the source node 302. In an illustrative embodiment, the source node 302 and the media distribution nodes 304-318 can each include one or more devices, such as one or more servers, switches, routers, or other devices that are adapted to perform one or more of the functions with respect to distributing media content, such as receiving a data packet, sending a data packet, storing data, determining one or more network paths, and other functions of nodes within an Internet Protocol (IP) backbone network or other media distribution network.

As illustrated in FIG. 3A, the various nodes 302-318 of the media distribution network are connected via a plurality of bi-directional network links, such as the links 322 and 324. In a particular embodiment, initial link weighting factors can be set for each of the links in the system 300 to manipulate the determination of particular initial primary paths by each of the media distribution nodes 302-318. A desired initial multicast tree can be produced based on the initial primary paths. The initial link weighting factors can be set according to a process that results in a multicast tree in which each media distribution node (MDN) receives only one copy of each data packet sent by the source node; in which no backup path of the multicast tree overlaps any primary path of the multicast tree, at least during a single-link failure within the system 300; and in which each MDN receives data packets via a shortest open path from the source 302 while meeting the other criteria.

In an illustrative embodiment, the initial link weighting factors can be set by identifying a first ring of network nodes within the system, where the ring includes the source node 302. For example, a ring including the nodes S-1-5-6-2-S can be identified. Link weighting factors associated with one of the links coupled to the source node (e.g., 324) is set to high cost, and the other link coupled to the source node (e.g., 322) is set to low cost. As a result, the source node 302 can select an initial primary path that includes a downstream portion of the link between the source node 302 and MDN(1) 304. Link weighting factors associated with other links on the first ring can also be set to low cost, such that MDN(1) 304, MDN(5) 312 and MDN(6) 314 select initial primary paths that direct data flow about the first ring. Note that if a clockwise direction is desired, the link 322 would be set at high cost and the link 324 would be set at low cost. Nonetheless, the other links associated with the first ring would still be set at low cost.

The first ring forms an initial undirected graph of the system 300. After link weighting factors are set for the first ring, a series of links are identified that form a path having two endpoints on the first ring. For example, a series of links forming the path 1-3-5 can be identified. A link weighting factor associated with the first or last link in the series can be set at a high cost, and the other links of the series can be set at a low cost. In the series of links forming the path 1-3-5, the link between MDN(1) 304 and MDN(5) 312 is the last link in the series. This link is already set at a low cost during link weight setting for the first ring. Hence, the first link in the 1-3-5 series (the link between MDN(1) 304 and MDN(3) 308) is set to high cost. After link weighting factors are set for the series of links forming the path 1-3-5, the links between MDN(1) 304 and MDN(2) 308, and between MDN(3) 308 and MDN(5) 312, are added to the graph of the system 300. This process can be repeated with respect to other series of links, such as links that form the paths 3-4-6, 2-8-6, and 5-7-8, until all links have been assigned weighting factors and become part of the undirected graph of the system 300.

After all link weighting factors are set for the system 300, the network nodes 302-318 determine primary paths for the system 300, by calculating the next best hop from each network node based on the link weighting factors. Each initial primary path follows a downstream portion of a link having a pair of directed edges (e.g., upstream and downstream). An initial multicast tree is generated for the system 300 based on the initial primary paths. The initial primary paths are shown at 319 in the multicast tree 330 depicted in FIG. 3B.

After the multicast tree is determined, backup paths can be generated by resetting weighting factors associated with the low cost links along the multicast tree to high cost and the high cost links of the multicast tree to low cost. Alternatively, second link weighting factors can be set for each of the network links. Backup paths can be determined at each of the network nodes 302-318 based on the reset or second link weighting factors. For example, we have the following backup paths for various network link pairs:

| S-1: | S-2-1; |
|---|---|
| 1-5: | 1-3-5; |
| 5-6: | 5-1-2-6; |
| 5-3: | 5-1-3; |
| 5-7: | 5-1-2-8-7; |
| 3-4: | 3-1-2-6-4; |
| 6-2: | 6-5-1-2; |
| 6-8: | 6-5-1-2-8; |

The backup paths and the initial primary paths of the multicast tree do not overlap.

In an illustrative embodiment, a failure of one of the network links included in the system 300 can be detected. For instance, MDN(6) 314 can detect a failure of the network link between MDN(6) 314 and MDN(2) 306. In response to the link failure, data packets received at MDN(6) 314 can be re-routed to MDN(2) 306 via the backup path 320. Re-routing of data packets via the backup path 320 can be initiated via a link layer fast re-route (FRR) mechanism at MDN(6) 314, such that the failure remains transparent to an IP Open Shortest Path First (IP-OSPF) protocol that maintains the system topology.

Alternatively, the link failure can be reflected at the Internet Protocol (IP) layer of the system 300, for example, by setting a high cost for the backup path 320. In an illustrative embodiment, new link weighting factors, including a very high cost (e.g., infinity) for the failed network link, can be set for the network links according to a re-convergence process associated with the IP-OSPF protocol. Some or all of the re-computed primary paths can be different from the initial primary paths.

In a particular embodiment, the new link weighting factors can be set using a process similar to that used to set the initial link weighting factors, while accounting for the link failure. For instance, a series of links forming a first ring would not include the link between MDN(2) 306 and MDN(6) 314 when setting new link weighting factors via the process described previously with respect to FIG. 3A. In a particular embodiment, new link weighting factors can be set automatically by a network management or monitoring system, or at each network node, in response to a synchronous optical networking (SONET) alarm, Bidirectional Failure Detection (BFD), link state advertisement (LSA), or other error indication sent over the system 300 when the link failure is detected.

Once the new link weighting factors are set, the network nodes 302-318 can re-calculate their next best hops based on the new link weighting factors, thereby generating new primary paths, but not including the failed network link. A re-configured multicast tree that includes the new primary paths can be determined according to a protocol-independent multicast (PIM) protocol or other protocol. Each of the nodes 302-318 can also re-calculate its backup path based on the re-calculated primary paths. For example, each of the nodes 302-318 can apply the process described in connection with FIG. 3A to the new topology in order to determine its re-calculated backup path.

Each media destination can start sending data packets via the re-configured multicast tree when a routing protocol re-convergence period (e.g., an OSPF or IGP re-convergence period) ends; when the media destination begins receiving data via the re-configured multicast tree; when the media destination receives multicast “leave” messages from all child nodes to which it sends data via the previous multicast tree; or a combination thereof. In a particular embodiment, each of the nodes 302-318 can separately join the re-configured multicast tree using a “make-before-break” process, wherein a last hop router of each MDN issues a “join” command toward the source node 302 along the new shortest path of the re-configured multicast tree. In an illustrative embodiment, join commands can include a “join source shortest path” tree command of the form (S,G), in which S indicates the source 302 and G indicates a multicast group. Data starts to flow on the re-configured multicast tree, and the receiving MDN on the backup path 320 prunes the previous multicast tree (i.e., the tree as it existed prior to the failure) after receiving data packets via the re-configured multicast tree. For example, MDN(2) 306 can join the re-configured multicast tree when it begins receiving data packets via the re-configured multicast tree, and the backup path 320 can cease to be used. As a result, the changeover of each media destination from the initial multicast tree to the re-configured multicast tree can appear substantially “hitless” in terms of media quality received by subscribers.

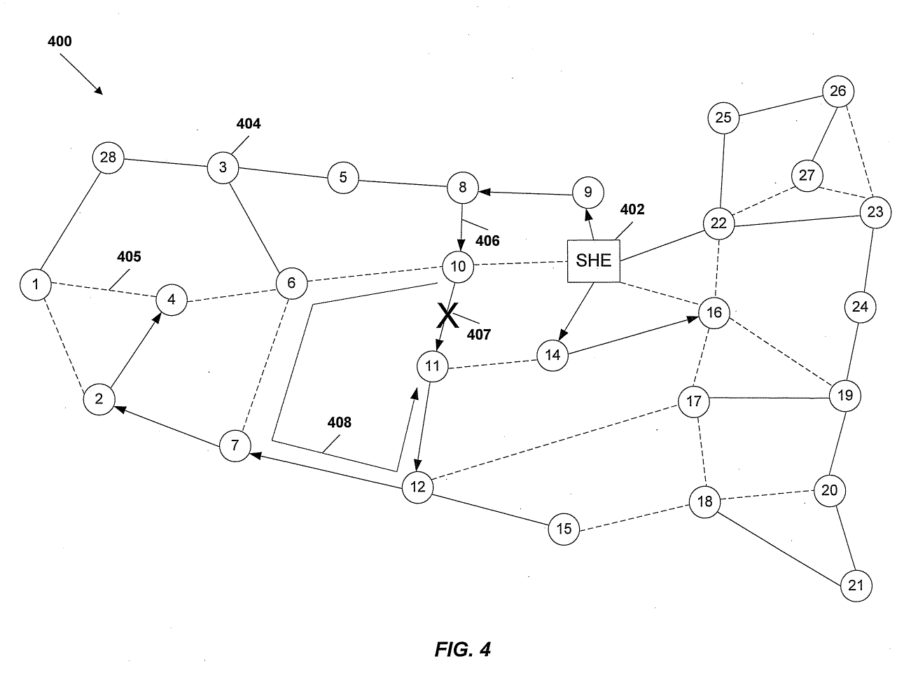

Referring to FIG. 4, a fourth particular embodiment of a system to distribute media content is illustrated and designated generally 400. The system 400 can include a multicast content source, such as the super head-end (SHE) 402, and a plurality of media distribution nodes 404. The SHE 402 and media distribution nodes 404 are coupled via a plurality of bi-directional network links 405. In a particular embodiment, the SHE 402 and the media distribution nodes 404 can form a national Internet Protocol (IP) backbone network. Each of the media distribution nodes 404 can receive data packets, or copies thereof, and can multicast corresponding video content, audio content, or any combination thereof, to metropolitan areas or other serving areas that may include regional or sub-regional media distribution nodes, set-top box devices, or any combination thereof. In a particular embodiment, each of the nodes 402, 404 can include one or more servers, multicast-enabled routers, or other devices, each of which can be adapted to perform one or more of functions with respect to distributing media content, such as receiving a data packet, sending a data packet, storing data, determining a network path, and other functions.

Link weighting factors can be set for the plurality of links 405. The media distribution nodes 404 can calculate initial primary paths, based on the link weighting factors, which give rise to a multicast tree for the system 400. In one embodiment, the link weighting factors can be set using a process similar to the process described with respect to FIG. 3A. For instance, a first ring can be identified that includes the SHE 402 (e.g., SHE-9-8-10-SHE). One of the links that is included in the first ring and that is coupled to the SHE 402 (the link coupled to SHE 402 and node(10)) can be assigned a high cost. The other link that is included in the first ring and that is coupled to the SHE 402 (e.g., the link coupled to the SHE 402 and node(9)) can be assigned a low cost. The other links in the first ring are also assigned a low cost. The first ring comprises an initial graph.

A series of links having two endpoints on the first ring can then be identified, such as the series of links that form the path 8-5-3-6-10. The last link in the series (node(6)-node(10)) can be assigned a high cost, and the other links in the series can be assigned a low cost. The series of links are then included in the graph. An additional series of links having two endpoints on the new graph can be identified, such as the series of links forming the path 10-11-12-7-6. The last link in the series (node(7)-node(6)) can be assigned a high cost, and the other links in the series can be assigned a low cost.

In an illustrative embodiment, a second ring can be identified that includes the SHE 402, such as the ring that includes the SHE 402, node(14) and node (16). One of the links that is coupled to the SHE 402 and that is included in the second ring can be assigned a low cost (SHE-node(14)), and the other such link can be assigned a high cost (SHE-node(16)). Link 14-16 is assigned a low cost. A next series of links having two endpoints on the second ring can be identified, such as SHE-16-22. The first link of the series (node(16)-node(22)) can be set to high cost, and the last link (node(22)-SHE) can be set to low cost. An additional series of links, such as 16-19-24-23-22 can be identified, and all but the first link (node(16)-node(19)) of the additional series can be set to low cost. This process can be repeated until link weighting factors have been assigned to all links of the system 400. In the embodiment shown in FIG. 4, links assigned a high cost are indicated by dashed lines, whereas links assigned a low cost are indicated by solid lines in FIG. 4.

Each of the media distribution nodes selects an initial primary path based on the pre-set link weighting factors. An initial multicast tree can be determined based on the initial primary paths 406, such that the multicast tree includes the low cost links of the system 400. In addition, each of the media distribution nodes can determine a fast re-route (FRR) backup path, such as the backup path 408, to re-route data to a next node in case of a failure of a link between the two nodes. The FRR paths do not overlap any of the initial primary paths 406 of the multicast tree. For example, the backup path 408 does not overlap any of the initial primary paths in the series of links forming the path 10-11-12-7-2-4.

In an illustrative embodiment, a link failure 407 can occur within the system 400. Node(10) can detect the link failure 407 and re-route data to node(11) via the backup path 408. Further, node(10) can send a link state advertisement throughout the network assigning a high cost to the backup path 408. Link weighting factors can be reset for each of the network links 405, including a high cost being set for the links of the backup path associated with the network failure 407. Once the link weighting factors are reset, each of the nodes can re-calculate its primary path, and a re-configured multicast tree that includes the re-computed primary paths and avoids the failed link and the backup path 408 can be determined. The re-configured multicast tree can satisfy criteria similar to those fulfilled by the initial multicast tree, namely that each media distribution node 404 receives only one copy of each data packet sent by the SHE 402, and that no re-computed FRR path overlaps any re-computed primary path. In a particular embodiment, each of the media distribution nodes 404 can separately join the re-configured multicast tree and leave the initial multicast tree after re-configuration of the multicast tree is complete.

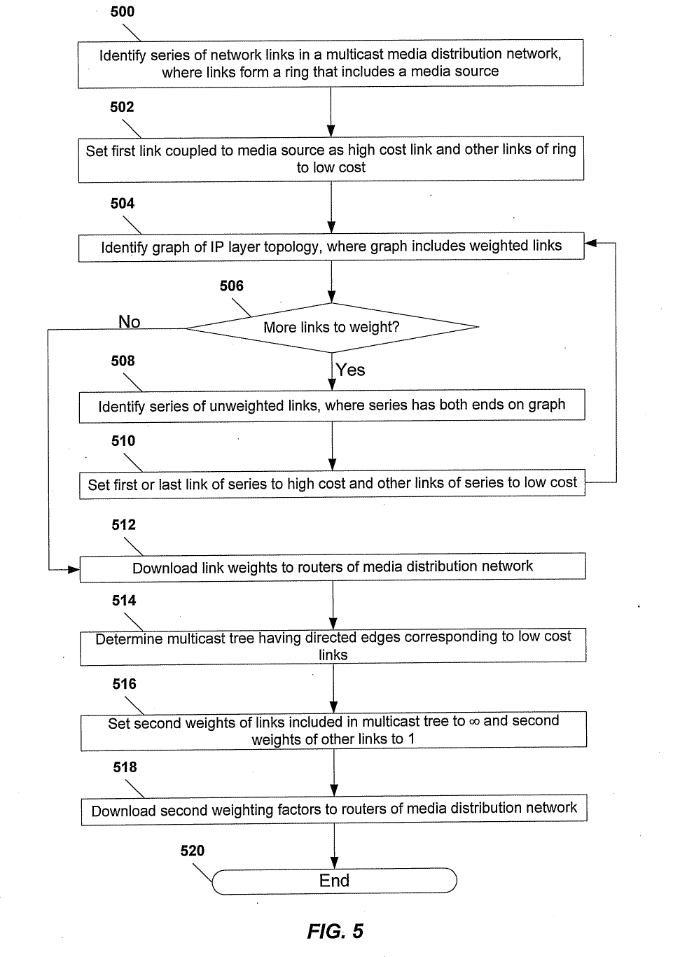

Referring to FIG. 5, a particular embodiment of a method of distributing media content is illustrated. At block 500, a series of network links in a multicast media distribution network is identified, where the series of network links forms a ring that includes a media content source. Moving to block 502, a first link that is included in the ring and that is coupled to the media content source is assigned a high cost. The other links included in the ring are assigned a low cost. Proceeding to block 504, a graph of the Internet Protocol (IP) layer topology of the network is identified, where the graph includes the weighted links of the ring. Continuing to decision node 506, it is determined whether the multicast media distribution network includes more links to be assigned weighting factors. If there are no additional links to be assigned weighting factors, the method can advance to block 512.

On the other hand, if additional links remain to be assigned weighting factors, the method moves to block 508. At block 508, a series of unweighted links is identified where the series forms a path that has two endpoints on the graph determined at 506. Proceeding to block 510, a first link or last link of the series of unweighted links is set to a high cost, and the other links included in the series of unweighted links are set to a low cost. The method returns to 506, and the links weighted at 510 are included in the graph of the IP layer topology.

Once all network links of the multicast media distribution network are weighted, the method advances to block 512. At block 512, the link weighting factors determined at 500-510 are downloaded to routers at nodes of the multicast media distribution network, e.g., through router configuration software or other network management software. In a particular embodiment, the link weighting factors sent to a particular router can relate to the links coupled to the particular router, links coupled to neighboring routers, or any combination thereof. In another embodiment, all link weighting factors can be downloaded to each router.

Moving to block 514, a multicast tree is determined for the multicast media distribution network. The multicast tree includes directed edges corresponding to the low cost links of the multicast media distribution network. In one embodiment, the multicast tree can be constructed based on multicast JOIN messages issued by each media distribution node, as the JOIN messages follow a shortest path through the routers of the media distribution nodes to the media content source. Proceeding to block 516, in a particular embodiment, second weighting factors can be set for the links of the multicast media distribution network. The directed edges included in the multicast tree can be set to a high cost, such as 100, ∞, or another high cost, and the other edges of the multicast media distribution network can be set to a low cost, such as 1, 0, −∞, or another low cost. In an illustrative embodiment, the second weighting factors can be used to calculate backup paths that do not overlap the multicast tree. Continuing to block 518, the second weighting factors are downloaded to the routers at the media distribution nodes of the multicast media distribution network. The method terminates at 520.

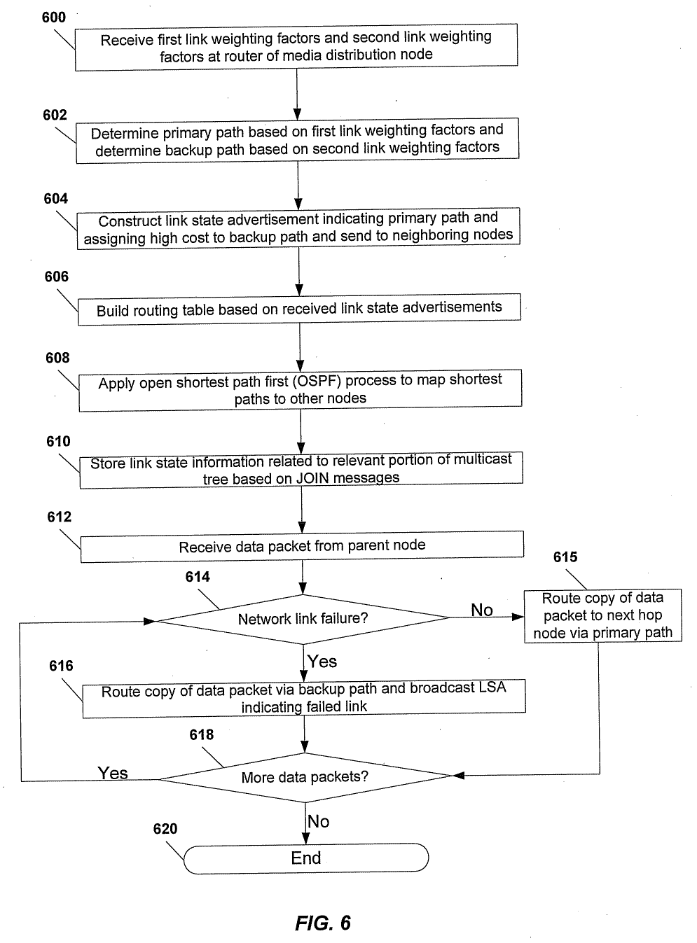

Referring to FIG. 6, a second particular embodiment of a method of distributing media content is illustrated. At 600, a router at a media distribution node (a “node”) of a multicast media distribution network receives first link weighting factors and second link weighting factors. The link weighting factors can be received from a network management system and can be determined according to the method illustrated with respect to FIG. 5. In a particular embodiment, the link weighting factors received by the router can relate to the links coupled to the router, links coupled to routers of neighboring nodes, or any combination thereof. In another embodiment, the router can receive link weighting factors related to all links of the multicast media distribution network.

Moving to block 602, the router determines a primary path based on the first link weighting factors. For example, the router can select a primary path corresponding to a bi-directional link that was assigned the lowest cost among links to which the router is coupled. The router is adapted to send copies of received data packets to a downstream node via the selected primary path. Further, the router determines a backup path based on the second link weighting factors. The router is adapted to re-route data packets to the downstream node via the backup path in response to a failure of a link corresponding to the primary path. The backup path does not overlap any primary path of a multicast tree corresponding to data flow through the multicast media distribution network. Proceeding to block 604, the router can construct a link state advertisement (LSA) indicating the costs of the links to which it is coupled. The router can send the LSA to one or more routers at neighboring nodes. In an illustrative embodiment, LSAs can be delivered via a control plane of the multicast media distribution network that is separate from a data plane that is used to deliver data packets.

Continuing to block 606, the router builds a routing table based on LSAs received via routers at the neighboring nodes. The routing table can indicate, for example, which nodes of the multicast media distribution network are connected to particular other nodes (i.e. the network topology). Further, the routing table can indicate how data can be routed, or is to be routed, to other particular nodes. Advancing to block 608, the router applies an open shortest path first (OSPF) process, in order to determine the shortest path to at least one other node, such as a desired parent, a media source, or a combination thereof, given the network topology. At block 610, the router can store link state information related to a portion of a multicast tree that is relevant to the router, such as a portion that includes the router, one or more downstream nodes to which the router is to communicate data packets, a path from the router to the root of the multicast tree (e.g., the media source), or any combination thereof. In one embodiment, the router can determine which downstream nodes (i.e., receivers at routers associated with the downstream nodes) are to receive data packets from the router based on JOIN messages received from the downstream routers.

Moving to block 612, the router receives a data packet, such as a video data packet, an audio data packet, or any combination thereof, from a parent node. Proceeding to decision node 614, the router determines whether the network link corresponding to the primary path determined at 602 has failed. For example, the router can utilize a link state protocol process to determine a status of each link coupled to the router. Link status can be determined periodically, when each data packet is received, or any combination thereof. If the link corresponding to the primary path has not failed, the method continues to block 615, and the router routes the data packet to the downstream node via the primary path. The method then advances to decision node 618.

Returning to decision node 614, if the router determines that the link corresponding to the primary path has failed, the method proceeds to block 616, and the router routes the data packet to the downstream node via the backup path. The router can also broadcast a link state advertisement to neighboring nodes indicating the link failure. In other embodiments, the multicast media distribution network can utilize a Lightweight Hello protocol built on User Datagram Protocol/Internet Protocol (UDP/IP) to determine whether each link is operational. In yet another embodiment, a SONET alarm can be broadcast to the multicast media distribution network indicating the failed link. The method then advances to decision node 618.

At decision node 618, the router determines whether additional data packets have been received. If additional data packets are received, the method returns to decision 614. The additional data packets can be routed via the primary path if the link is operational, or via the backup path if the link is non-operational. If no additional data packets are received, the method terminates at 620.

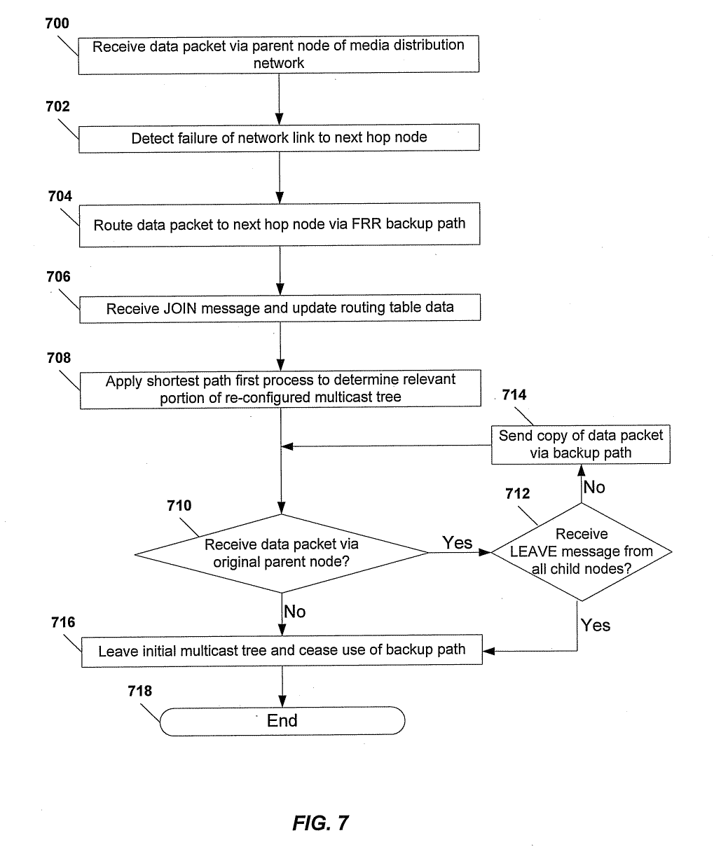

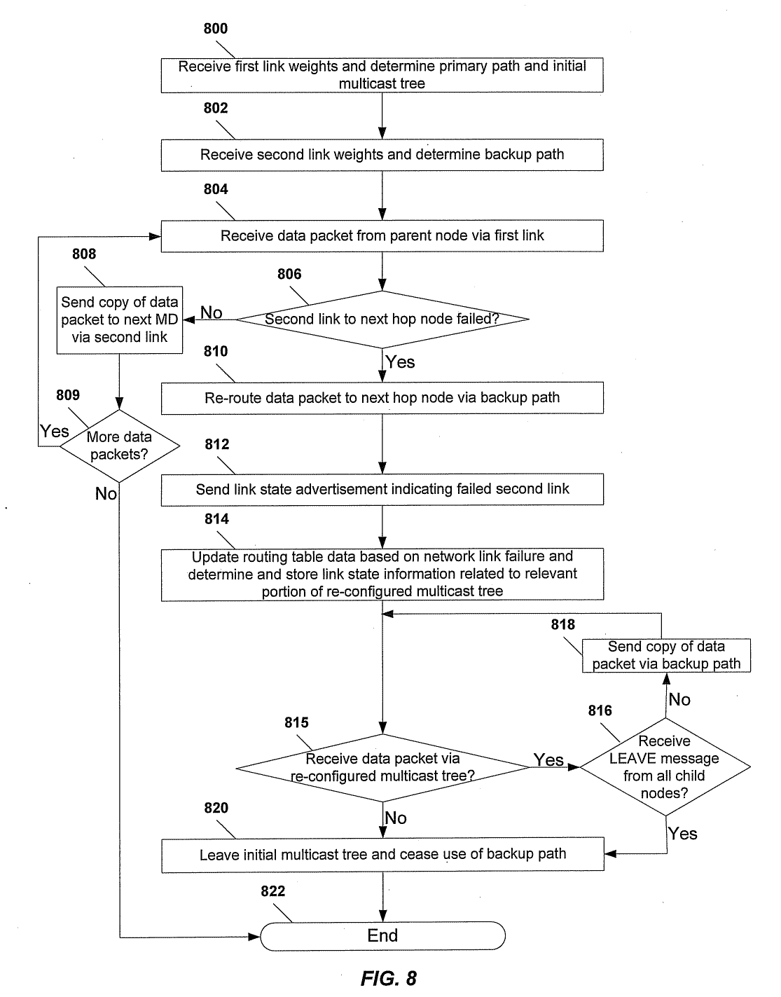

Referring to FIG. 7, a third particular embodiment of distributing media content is illustrated. At block 700, a router at a media distribution node (a “node”) of a multicast media distribution network receives a data packet from a parent node. Moving to block 702, the node detects a failure of a network link that couples the node to a next hop node. Proceeding to block 704, the node routes the data packet to the next hop node via a fast re-route backup path that does not overlap an initial multicast tree previously determined by the node.

Continuing to block 706, the router updates its routing table based on the link failure. Additionally, the router may update the routing table based on multicast JOIN messages received from downstream nodes. For example, where the router receives a JOIN request from a downstream node after the network link failure, the JOIN request will be sent via a shortest open path that avoids the failed network link. The router can update its routing table to record that shortest open path. Advancing to block 708, in a particular embodiment, the router applies an open shortest path first (OSPF) process to update its link state information and determine a portion of a re-configured multicast tree that is relevant to the router, where the re-configured multicast tree begins at the media content source and excludes the failed network link. The OSPF process can include determining a shortest open path between the router and the media content source. The relevant portion of the re-configured multicast tree can be constructed by appending the shortest path between the router and the media content source to the shortest open path by which the router has received a JOIN message from a downstream node after the link failure.

At decision node 710, the router can determine whether it has received any data packet(s) via the re-configured multicast tree (i.e., the path from the media content source to the router). If the media destination router has received one or more data packets via the re-configured multicast tree, the method advances to block 716. Conversely, if the media destination router has not received any data packet(s) via the re-configured multicast tree, the method moves to decision node 712, and the media destination router can determine whether it has received LEAVE messages from all child nodes corresponding to the initial multicast tree. If the router has not received such LEAVE messages, the method can proceed to block 714, and the media destination router can send any additional data packets that it receives via the backup path. On the other hand, if the media destination has received LEAVE messages from all child nodes corresponding to the initial multicast tree, the method moves to block 716.

At block 716, the router leaves the initial multicast tree and ceases to send any additional data packets via the backup path. The method terminates at 718.

Referring to FIG. 8, a fourth particular embodiment of a method of distributing media content is illustrated. At block 800, a router at a media destination of a media distribution network receives first link weighting factors and determines a primary path to a router at a next hop media destination based on the first link weighting factors. Moving to block 802, the media destination router receives second link weighting factors and determines a backup path based on the second link weighting factors, where the backup path does not overlap an initial multicast tree that includes the primary path and corresponds to data flow through the media distribution network.

Proceeding to block 804, the media destination router receives a data packet from a parent node. Continuing to decision node 806, the media destination router determines whether a link to the next hop media destination has failed. If the link has not failed, the method advances to block 808, and the media destination router can send a copy of the data packets to the next media destination via the link. At decision node 806, the router can determine whether it has received other data packets. If the router has not received other data packets, the method terminates at 822. Conversely, if the router has received additional data packets, the method can return to block 804.

Returning to decision node 806, if the link has failed, the method moves to block 810, and the media destination router re-routes the data packet to the next hop media destination via the backup path determined at 802. Proceeding to block 812, the media destination router can send a link state advertisement (LSA) throughout the network indicating the failed network link. In an illustrative embodiment, a control plane associated with the router that generates the LSA operates based on detecting the link failure. The data plane associated with the router, which sends data packets via the backup path, can operate independently of the control plane. In one embodiment, the LSA can indicate a high cost assigned to the backup path. The high cost can be assigned to the backup path, for example, when the backup path is determined (at 802). The LSA communicates this high cost to other routers of the network.

Continuing to block 814, the media destination router updates its routing table based on the link failure. Additionally, the router can store updated link state information related to a relevant portion of a re-configured multicast tree. Advancing to decision node 815, the media destination router can determine whether it has received any data packets via the re-configured multicast tree. If the media destination router has received data packets via the re-configured multicast tree, the method advances to block 820. Conversely, if the media destination router has not received any data packets from the original parent node, the method moves to decision node 816, and the media destination router can determine whether it has received leave messages from all child nodes of the media destination according to the initial multicast tree. If the media destination router has not received such leave messages, the method can proceed to block 818, and the media destination router can send any additional data packets that it receives via the backup path. On the other hand, if the media destination router has received leave messages from all child nodes of the media destination according to the initial multicast tree, the method moves to block 820.

At block 820, the media destination router leaves the initial multicast tree, for instance, by sending a multicast LEAVE message to its original parent node. The router ceases to send any additional data packets via the backup path. The method terminates at 822.

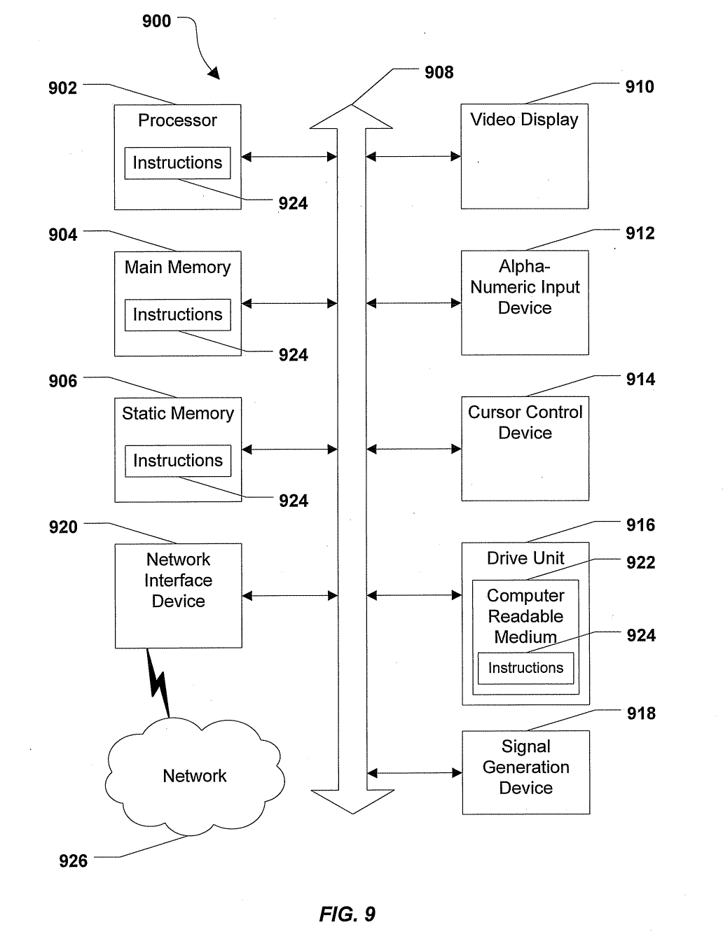

Referring to FIG. 9, an illustrative embodiment of a general computer system is shown and is designated 900. The computer system 900 can include a set of instructions that can be executed to cause the computer system 900 to perform any one or more of the methods or computer based functions disclosed herein. The computer system 900, or any portion thereof, may operate as a standalone device or may be connected, e.g., using a network, to other computer systems or peripheral devices.

In a networked deployment, the computer system may operate in the capacity of systems or devices of a media content source, video head-end, media distribution node, router, server, network management or monitoring system, or any combination thereof, as illustrated in FIGS. 1A-4. The computer system 900 can also be implemented as or incorporated into various user communication devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics-processing unit (GPU), or both. Moreover, the computer system 900 can include a main memory 904 and a static memory 906 that can communicate with each other via a bus 908. As shown, the computer system 900 may further include a video display unit 910, such as a liquid crystal display (LCD), an organic light emitting diode (OLED), a flat panel display, a solid state display, or a cathode ray tube (CRT). Additionally, the computer system 900 may include an input device 912, such as a keyboard, and a cursor control device 914, such as a mouse. The computer system 900 can also include a disk drive unit 916, a signal generation device 918, such as a speaker or remote control, and a network interface device 920.

In a particular embodiment, as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal, so that a device connected to a network 926 can communicate voice, video or data over the network 926. Further, the instructions 924 may be transmitted or received over the network 926 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of distributing media content, the method comprising:
setting a plurality of link weighting factors for a plurality of links of a multicast network, according to a process that includes:
identifying a first plurality of nodes of the multicast network, wherein the first plurality of nodes include a media content source and are connected via a first plurality of links to form a first ring;
setting a weighting factor associated with a particular link of the first plurality of links to a high cost and setting weighting factors associated with the other links in the first plurality of links to a low cost, wherein the particular link is coupled to the media content source;
forming a graph representing the multicast network, the graph including links of the multicast network that are associated with weighting factors and each pair of nodes connected via one of the included links;
identifying at least one additional series of links of the multicast network, where each additional series of links are unweighted and form a path having two endpoints on the graph of the multicast network; and
setting a weighting factor associated with a first or a last link in the additional series of links to the high cost and setting weighting factors associated with other links in the additional series of links to the low cost; and
downloading data related to the plurality of link weighting factors to each of a plurality of media destination routers of the multicast network, wherein the plurality of media destination routers are adapted to send and receive data packets according to a multicast tree that includes each of the plurality of links whose weighting factor is equal to the low cost.

2. The method of claim 1, wherein data downloaded to a particular media destination router includes link weighting factors related to links to which the particular media destination router is coupled.

3. The method of claim 1, wherein each of the plurality of media destination routers is adapted to calculate a primary path to a next hop media destination based on at least one of the plurality of link weighting factors.

4. The method of claim 1, further comprising generating the multicast tree based on the plurality of link weighting factors.

5. The method of claim 1, further comprising setting a plurality of second link weighting factors for the plurality of links of the multicast network, wherein each second link weighting factor associated with a link included in the multicast tree is set to the high cost and wherein each second link weighting factor associated with a link not included in the multicast tree is set to the low cost.

6. The method of claim 5, further comprising downloading at least one of the plurality of second link weighting factors to each of the plurality of media destination routers.

7. The method of claim 6, wherein:
each of the plurality of media destination routers is adapted to determine a backup path for sending the data packets to a next hop node after a network link failure;
each backup path is determined based on at least one of the plurality of second link weighting factors; and
wherein each backup path flows in reverse to at least one primary path and does not overlap any primary path of the multicast tree.

8. The method of claim 1, wherein each of a plurality of media destinations receives only one copy of each data packet sent by the media content source via the multicast tree.

9. A method of distributing media content, the method comprising:
receiving first link weighting factors and second link weighting factors at a router associated with a media distribution node of a multicast media distribution network;
determining a primary path to a next hop media distribution node based on the first link weighting factors, wherein the primary path corresponds to a network link coupled to the router and to a second router of the next hop media distribution node and wherein the network link is associated with a low first link weighting factor;
determining a backup path from the router to the next hop media distribution node based on the second link weighting factors, wherein the backup path does not overlap any primary path between two media distribution nodes of the media distribution network;
receiving a data packet from a parent media distribution node; and
routing a copy of the data packet from the router to the next hop node via the backup path, when the network link coupled to the router and to the second router has failed.

10. The method of claim 9, further comprising routing additional data packets via the backup path, until a pre-defined event, wherein the pre-defined event includes the network link becoming operational, receiving multicast LEAVE messages from all child nodes of the router, receiving a respective data packet via a re-configured multicast tree, or any combination thereof.

11. The method of claim 9, further comprising storing link state information related to a portion of a multicast tree, wherein the portion is relevant to the router.

12. The method of claim 11, further comprising:
receiving a multicast JOIN message from a downstream router via a first shortest open path between the router and the downstream router before the network link has failed; and
determining a second shortest open path between the router and a media content source;
wherein the relevant portion of the multicast tree is a portion of an initial multicast tree and includes the first shortest open path and the second shortest open path.

13. The method of claim 11, further comprising:
receiving a multicast JOIN message from a downstream router via a first shortest open path between the router and the downstream router that avoids the failed network link; and
determining a second shortest open path between the router and a media content source;
wherein the relevant portion of the multicast tree is a portion of a re-configured multicast tree that excludes the failed network, and wherein the relevant portion includes the first shortest open path and the second shortest open path.

14. The method of claim 9, further comprising broadcasting a link state advertisement indicating the failed network link to other media distribution nodes of the multicast media distribution network.

15. A system to distribute media content, the system comprising:
a router associated with a node of a media distribution network, wherein the router is adapted to:
receive a data packet from a parent node of the media distribution network;
route a copy of the data packet to a next hop node via a fast re-route backup path when a network link coupled to the router and to a second router of a next hop node is not operational, wherein the fast re-route backup path does not overlap any primary path of an initial multicast tree corresponding to data flow from the router to downstream nodes of the media distribution network;
construct a re-configured multicast tree that excludes the failed network link; and
route data packets via the re-configured multicast tree and cease routing data packets via the backup path in response to a re-convergence event.

16. The system of claim 15, wherein the re-convergence event includes receiving additional data packets via the re-configured multicast tree, receiving multicast LEAVE messages from all child nodes of the router according to the initial multicast tree, or any combination thereof.

17. The system of claim 15, wherein the router is adapted to send a multicast JOIN message to the media content source in response to the re-convergence event, where the JOIN message is sent via a shortest path through the media distribution network that excludes the failed network link.

18. The system of claim 15, wherein the router is adapted to construct the re-configured multicast tree based on a plurality of multicast JOIN messages sent to a media content source from the downstream nodes of the media distribution network, via the router, after the network link has failed.

19. The system of claim 18, wherein the router updates a routing table stored at the router to include state information indicating that the downstream nodes are to receive copies of data packets via the router according to the re-configured multicast tree.

20. The system of claim 15, wherein the router is one of a plurality of routers at the media distribution node.

21. The system of claim 20, wherein the plurality of routers includes a designated router and a backup designated router that is at least partially redundant to the designated router.

22. A system to distribute media content, the system comprising:
a router associated with a node of a media distribution network, wherein the router is adapted to:
determine a primary path to a next hop media distribution node based on first link weighting factors received at the router, wherein the primary path corresponds to a network link coupled to the router and to a second router of a next hop media distribution node;
determine a backup path from the router to the next hop media distribution node based on second link weighting factors received at the router, wherein the backup path does not overlap an initial multicast tree that includes the primary path;
route a copy of a data packet received at the router from a parent node to the next hop media distribution node via the backup path when a network link coupled to the router and to the second router is not operational;
determine a re-configured multicast tree that excludes the network link that is not operational; and
route data packets via the re-configured multicast tree and cease routing data packets via the backup path in response to a re-convergence of a routing protocol.

23. The system of claim 22, wherein the router is adapted to receive the first link weighting factors and second link weighting factors from a network management system.

24. The system of claim 22, wherein the router is adapted to receive the first link weighting factors and second link weighting factors via router configuration software.

25. The system of claim 22, wherein the network link is associated with a lowest first link weighting factor.

26. The system of claim 22, wherein the network link is associated with a highest first link weighting factor.

27. The system of claim 22, wherein the router includes a receiver adapted to receive the first link weighting factors, the second link weighting factors, link state advertisements from neighboring media distribution nodes, multicast JOIN messages from downstream media distribution nodes, multicast LEAVE messages from downstream media distribution nodes, or any combination thereof.

28. The system of claim 22, wherein the routing protocol is an interior gateway protocol (IGP).

29. The system of claim 28, wherein the IGP is a link-state routing protocol.

30. The system of claim 29, wherein the link-state routing protocol is an open shortest path first protocol (OSPF), OSPF version 3 (OSPFv3) protocol, intermediate system-to-intermediate system (IS-IS) protocol, or multicast OSPF (MOSPF) protocol.

31. A computer-readable medium having processor-readable instructions that are executable by a processor to perform a method, the method comprising:
setting a plurality of link weighting factors for a plurality of links of a multicast network, according to a process that includes:
identifying a first plurality of nodes of the multicast network, wherein the first plurality of nodes include a media content source and are connected via a first plurality of links to form a first ring;
setting a weighting factor associated with a particular link of the first plurality of links to a high cost and setting weighting factors associated with the other links in the first plurality of links to a low cost, wherein the particular link is coupled to the media content source;
forming a graph representing the multicast network, the graph including links of the multicast network that are associated with weighting factors and each pair of nodes connected via one of the included links;
identifying at least one additional series of links of the multicast network, where each additional series of links are unweighted and form a path having two endpoints on the graph of the multicast network; and
setting a weighting factor associated with a first or a last link in the additional series of links to the high cost and setting weighting factors associated with other links in the additional series of links to the low cost; and
downloading data related to the plurality of link weighting factors to each of a plurality of media destinations of the multicast network.

32. The computer-readable medium of claim 31, wherein the low cost is equal to one and the high cost is equal to infinity.

33. The computer-readable medium of claim 31, wherein the multicast tree is generated according to a Protocol Independent Multicast (PIM) protocol.

34. The computer-readable medium of claim 31, wherein the plurality of media destinations are adapted to send and receive data packets according to a multicast tree that includes each of the plurality of links whose weighting factor is equal to the low cost.

35. The computer-readable medium of claim 34, wherein the data packets include video content, audio content, or any combination thereof.
